(19) United States
(12) Patent Application Publication
(10) Pub. No.: US 2025/0261109 A1
(43) Pub. Date: Aug. 14, 2025

(54) ON-DEMAND SYNCHRONIZATION SIGNALING FOR NETWORK ENERGY SAVINGS SYSTEMS

(71) Applicant: QUALCOMM Incorporated, San Diego, CA (US)

(72) Inventors: Keerthi Priya DASALA, West Lafayette, IN (US); Navid ABEDINI, Basking Ridge, NJ (US); Jianghong LUO, Skillman, NJ (US)

(21) Appl. No.: 18/437,180

(22) Filed: Feb. 8, 2024

(51) Int. Cl. H04W 52/02

(52) U.S. Cl. CPC H04W 52/0229

(57) ABSTRACT

Methods, systems, and devices for wireless communications are described. A user equipment (UE) may communicate with a first network entity associated with a network energy savings (NES) cell and a second network entity associated with an anchor cell. In some examples, the UE may receive assistance information from the anchor cell including an indication of parameters for establishing communications with the NES cell. The UE may receive a first signal from the NES cell that indicates a first portion of the parameters. The first portion may be based on the assistance information. The UE may transmit a wake up signal (WUS) to the NES cell including an indication of the first portion of the parameters. The NES cell may receive the WUS and transmit a second signal including an indication of the remaining one or more parameters to the UE based on receiving the first signal.

### FIELD OF TECHNOLOGY

The following relates to wireless communications, including on-demand synchronization signaling for network energy savings systems.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support on-demand synchronization signaling for network energy savings systems. For example, the described techniques provide for a user equipment (UE) configured to communicate with a first network entity associated with a network energy savings (NES) cell and a second network entity associated with an anchor cell. In some examples, the UE may receive assistance information from the anchor cell including an indication of one or more parameters for establishing communications with the NES cell. The UE may receive a first signal from the NES cell that indicates first timing information (e.g., a portion of the one or more parameters) for establishing communications with the NES cell. In some cases, the first timing information may be based on the assistance information. Responsive to receiving the first signal, the UE may transmit a wake up signal (WUS) to the NES cell including an indication of the first timing information. The NES cell may receive the WUS and determine second timing information (e.g., the remaining one or more parameters) based on the indication of the first timing information. Accordingly, the NES cell may transmit a second signal including an indication of the second timing information to the UE.

A method by a UE is described. The method may include receiving assistance information for detecting a network entity, the assistance information including an indication of a distribution of a set of parameters across cell acquisition signaling for the network entity, the set of parameters for communicating with the network entity, receiving, from the network entity, a first signal of the cell acquisition signaling including a first indication of a first subset of the set of parameters, transmitting a WUS to the network entity based on receiving the first signal, and receiving, from the network entity based on transmitting the WUS, a second signal of the cell acquisition signaling including a second indication of a second subset of the set of parameters.

A UE is described. The UE may include one or more memories storing processor executable code, and one or more processors coupled with the one or more memories. The one or more processors may individually or collectively be operable to execute the code to cause the UE to receive assistance information for detecting a network entity, the assistance information including an indication of a distribution of a set of parameters across cell acquisition signaling for the network entity, the set of parameters for communicating with the network entity, receive, from the network entity, a first signal of the cell acquisition signaling including a first indication of a first subset of the set of parameters, transmit a WUS to the network entity based on receiving the first signal, and receive, from the network entity based on transmitting the WUS, a second signal of the cell acquisition signaling including a second indication of a second subset of the set of parameters.

Another UE is described. The UE may include means for receiving assistance information for detecting a network entity, the assistance information including an indication of a distribution of a set of parameters across cell acquisition signaling for the network entity, the set of parameters for communicating with the network entity, means for receiving, from the network entity, a first signal of the cell acquisition signaling including a first indication of a first subset of the set of parameters, means for transmitting a WUS to the network entity based on receiving the first signal, and means for receiving, from the network entity based on transmitting the WUS, a second signal of the cell acquisition signaling including a second indication of a second subset of the set of parameters.

A non-transitory computer-readable medium storing code is described. The code may include instructions executable by one or more processors to receive assistance information for detecting a network entity, the assistance information including an indication of a distribution of a set of parameters across cell acquisition signaling for the network entity, the set of parameters for communicating with the network entity, receive, from the network entity, a first signal of the cell acquisition signaling including a first indication of a first subset of the set of parameters, transmit a WUS to the network entity based on receiving the first signal, and receive, from the network entity based on transmitting the WUS, a second signal of the cell acquisition signaling including a second indication of a second subset of the set of parameters.

In some examples of the method, user equipment (UEs), and non-transitory computer-readable medium described herein, the first signal includes a primary synchronization signal (PSS) and the second signal includes a secondary synchronization signal (SSS) and a physical broadcast channel (PBCH).

In some examples of the method, user equipment (UEs), and non-transitory computer-readable medium described herein, the first signal includes an SSS and the second signal includes an PSS and a PBCH.

In some examples of the method, user equipment (UEs), and non-transitory computer-readable medium described herein, the first signal includes an PSS and an SSS and the second signal includes a standalone PBCH.

In some examples of the method, user equipment (UEs), and non-transitory computer-readable medium described herein, the first signal includes a channel state information reference signal (CSI-RS) or a tracking reference signal (TRS) and the second signal includes a physical downlink control channel (PDCCH) and a physical downlink shared channel (PDSCH) carrying partial master information block (MIB) and system information block (SIB) information or a non-scheduling PDCCH.

In some examples of the method, user equipment (UEs), and non-transitory computer-readable medium described herein, the set of parameters include an index for a set of cell identifiers (IDs), one or more least significant bits of a beam index, a half-frame index, one or more least significant bits of a system frame number, a symbol index, or an anchor cell timing delta value, an index for a configuration of a set of configurations, or any combination thereof.

Some examples of the method, user equipment (UEs), and non-transitory computer-readable medium described herein may further include operations, features, means, or instructions for determining, based on the index for the set of cell IDs, one or more candidate cells available for communications with an anchor cell, the UE, or both, where at least one of the one or more candidate cells may be associated with the network entity.

Some examples of the method, user equipment (UEs), and non-transitory computer-readable medium described herein may further include operations, features, means, or instructions for receiving, from an anchor cell, an indication of a set of configurations for one or more signals communicated by the network entity, the set of configurations including a cell identifier, timing information, frequency information, spatial information, beam information, cell barring information, a resource configuration, or any combination thereof.

Some examples of the method, user equipment (UEs), and non-transitory computer-readable medium described herein may further include operations, features, means, or instructions for receiving, from the network entity, an indication of an index for a configuration of the set of configurations and identifying a format of the second signal based on the index, where the UE receives the second signal in accordance with the configuration of the set of configurations and based on identifying the format of the second signal.

In some examples of the method, user equipment (UEs), and non-transitory computer-readable medium described herein, the one or more signals include the second signal of the cell acquisition signaling.

Some examples of the method, user equipment (UEs), and non-transitory computer-readable medium described herein may further include operations, features, means, or instructions for receiving, from an anchor cell, an indication of a configuration for transmitting the WUS, the configuration indicating resources associated with a first level of information associated with the first subset of the set of parameters and transmitting, via the resources indicated in the configuration, an indication of the first level of information based on receiving the indication, where the first level of information may be based on the first signal of the cell acquisition signaling including the first indication of the first subset of the set of parameters.

In some examples of the method, user equipment (UEs), and non-transitory computer-readable medium described herein, the UE transmits the indication of the first level of information via the WUS, the indication included in a scrambling identifier of the WUS, a preamble identifier of the WUS, a cyclic shift value of the WUS, a message payload transmitted by the UE, or any combination thereof.

In some examples of the method, user equipment (UEs), and non-transitory computer-readable medium described herein, transmitting the WUS may include operations, features, means, or instructions for transmitting an indication of an index for a first level of information associated with the first subset of the set of parameters, where the first level of information may be preconfigured at the UE.

In some examples of the method, user equipment (UEs), and non-transitory computer-readable medium described herein, receiving the second signal may include operations, features, means, or instructions for receiving an indication of a second level of information associated with the second signal and the second subset of the set of parameters based on transmitting the WUS to the network entity.

In some examples of the method, user equipment (UEs), and non-transitory computer-readable medium described herein, the UE receives the indication via a header in a payload of the second signal, a flag in a physical downlink control channel associated with the second signal, a scrambling identifier, a demodulation reference signal associated with the second signal, time and frequency resources associated with receiving the second signal, or any combination thereof.

Some examples of the method, user equipment (UEs), and non-transitory computer-readable medium described herein may further include operations, features, means, or instructions for receiving, from the network entity and based on receiving the second signal, a third signal of the cell acquisition signaling including a third subset of the set of parameters.

A method by a network entity is described. The method may include transmitting assistance information for detecting the network entity, the assistance information including an indication of a distribution of a set of parameters across cell acquisition signaling transmitted from the network entity, the set of parameters for communicating with the network entity, transmitting, to a UE, a first signal of the cell acquisition signaling including a first indication of a first subset of the set of parameters, receiving a WUS from the UE based on transmitting the first signal, and transmitting, to the UE based on receiving the WUS, a second signal of the cell acquisition signaling including a second indication of a second subset of the set of parameters.

A network entity is described. The network entity may include one or more memories storing processor executable code, and one or more processors coupled with the one or more memories. The one or more processors may individually or collectively be operable to execute the code to cause the network entity to transmit assistance information for detecting the network entity, the assistance information including an indication of a distribution of a set of parameters across cell acquisition signaling transmitted from the network entity, the set of parameters for communicating with the network entity, transmit, to a UE, a first signal of the cell acquisition signaling including a first indication of a first subset of the set of parameters, receive a WUS from the UE based on transmitting the first signal, and transmit, to the UE based on receiving the WUS, a second signal of the cell acquisition signaling including a second indication of a second subset of the set of parameters.

Another network entity is described. The network entity may include means for transmitting assistance information for detecting the network entity, the assistance information including an indication of a distribution of a set of parameters across cell acquisition signaling transmitted from the network entity, the set of parameters for communicating with the network entity, means for transmitting, to a UE, a first signal of the cell acquisition signaling including a first indication of a first subset of the set of parameters, means for receiving a WUS from the UE based on transmitting the first signal, and means for transmitting, to the UE based on receiving the WUS, a second signal of the cell acquisition signaling including a second indication of a second subset of the set of parameters.

A non-transitory computer-readable medium storing code is described. The code may include instructions executable by one or more processors to transmit assistance information for detecting the network entity, the assistance information including an indication of a distribution of a set of parameters across cell acquisition signaling transmitted from the network entity, the set of parameters for communicating with the network entity, transmit, to a UE, a first signal of the cell acquisition signaling including a first indication of a first subset of the set of parameters, receive a WUS from the UE based on transmitting the first signal, and transmit, to the UE based on receiving the WUS, a second signal of the cell acquisition signaling including a second indication of a second subset of the set of parameters.

In some examples of the method, network entities, and non-transitory computer-readable medium described herein, the first signal includes an PSS and the second signal includes an SSS and a PBCH.

In some examples of the method, network entities, and non-transitory computer-readable medium described herein, the first signal includes an SSS and the second signal includes an PSS and a PBCH.

In some examples of the method, network entities, and non-transitory computer-readable medium described herein, the first signal includes an PSS and an SSS and the second signal includes a standalone PBCH.

In some examples of the method, network entities, and non-transitory computer-readable medium described herein, the first signal includes a CSI-RS or a TRS and the second signal includes a PDCCH and an PDSCH carrying partial MIB and SIB information or a non-scheduling PDCCH.

In some examples of the method, network entities, and non-transitory computer-readable medium described herein, the set of parameters include an index for a set of cell IDs, one or more least significant bits of a beam index, a half-frame index, one or more least significant bits of a system frame number, a symbol index, or an anchor cell timing delta value, an index for a configuration of a set of configurations, or any combination thereof.

Some examples of the method, network entities, and non-transitory computer-readable medium described herein may further include operations, features, means, or instructions for transmitting, to the UE, an indication of an index for a configuration of a set of configurations for one or more signals communicated by the network entity, the set of configurations including a cell identifier, timing information, frequency information, spatial information, beam information, cell barring information, a resource configuration, or any combination thereof and transmitting a signal of the one or more signals in accordance with the configuration of the set of configurations.

Some examples of the method, network entities, and non-transitory computer-readable medium described herein may further include operations, features, means, or instructions for receiving, via a set of resources and based on transmitting the first signal, an indication of a first level of information, where the first level of information may be based on the first signal including the first indication of the first subset of the set of parameters.

In some examples of the method, network entities, and non-transitory computer-readable medium described herein, receiving the WUS may include operations, features, means, or instructions for receiving an indication of an index for a first level of information associated with the first subset of the set of parameters, where the first level of information may be preconfigured at the UE.

In some examples of the method, network entities, and non-transitory computer-readable medium described herein, transmitting the second signal may include operations, features, means, or instructions for transmitting an indication of a second level of information associated with the second signal and the second subset of the set of parameters based on receiving the WUS from the UE.

Some examples of the method, network entities, and non-transitory computer-readable medium described herein may further include operations, features, means, or instructions for transmitting, to the UE and based on transmitting the second signal, a third signal of the cell acquisition signaling including a third subset of the set of parameters.

In some examples of the method, network entities, and non-transitory computer-readable medium described herein, the network entity may be associated with one or more NES cells.

### BRIEF DESCRIPTION OF THE DRAWINGS

FIG. 1 shows an example of a wireless communications system that supports on-demand synchronization signaling for network energy savings systems in accordance with one or more aspects of the present disclosure.

FIG. 2 shows an example of a wireless communications system that supports on-demand synchronization signaling for network energy savings systems in accordance with one or more aspects of the present disclosure.

FIG. 3 shows an example of a process flow that supports on-demand synchronization signaling for network energy savings systems in accordance with one or more aspects of the present disclosure.

FIGS. 4 and 5 show block diagrams of devices that support on-demand synchronization signaling for network energy savings systems in accordance with one or more aspects of the present disclosure.

FIG. 6 shows a block diagram of a communications manager that supports on-demand synchronization signaling for network energy savings systems in accordance with one or more aspects of the present disclosure.

FIG. 7 shows a diagram of a system including a device that supports on-demand synchronization signaling for network energy savings systems in accordance with one or more aspects of the present disclosure.

FIGS. 8 and 9 show block diagrams of devices that support on-demand synchronization signaling for network energy savings systems in accordance with one or more aspects of the present disclosure.

FIG. 10 shows a block diagram of a communications manager that supports on-demand synchronization signaling for network energy savings systems in accordance with one or more aspects of the present disclosure.

FIG. 11 shows a diagram of a system including a device that supports on-demand synchronization signaling for network energy savings systems in accordance with one or more aspects of the present disclosure.

FIGS. 12 through 15 show flowcharts illustrating methods that support on-demand synchronization signaling for network energy savings systems in accordance with one or more aspects of the present disclosure.

### DETAILED DESCRIPTION

In some wireless communications systems, a user equipment (UE) may be in communications with an anchor cell. In some examples, the UE may be within a geographical coverage area of one or more serving cells associated with a respective one or more network entities. The UE may communicate with a network entity of the one or more network entities that is associated with a network energy saving (NES) cell. In some examples, the network entity may transmit a downlink reference signal (DL-RS) including information associated with the NES cell to the UE. The DL-RS may include synchronization information associated with the NES cell. For example, the DL-RS may include a portion of a synchronization signal block (SSB), such as a primary synchronization signal (PSS) and a secondary synchronization signal (SSS). However, in some examples, the DL-RS may not include the full synchronization information that is included in a SSB, and accordingly, the UE may not have enough information to establish communications with the network entity.

Various aspects of the present disclosure are directed to light and on-demand synchronization signaling for network energy savings systems. In some examples, a UE may be in communications with a first network entity associated with an NES cell and a second network entity associated with an anchor cell. In some examples, the UE may receive assistance information from the anchor cell (e.g., the second network entity) including an indication of one or more parameters for establishing communications with the NES cell (e.g., the first network entity). The UE may receive a first signal (e.g., a DL-RS) from the NES cell that indicates first timing information (e.g., a portion of the one or more parameters) for establishing communications with the NES cell. In some cases, the first signal may be based on the assistance information. Responsive to receiving the first signal, the UE may transmit a wake up signal (WUS) to the NES cell including an indication of the first timing information. The NES cell may receive the WUS and determine second timing information (e.g., the remaining one or more parameters) based on the indication of the first timing information. Accordingly, the NES cell may transmit a second signal including an indication of the second timing information to the UE.

Aspects of the disclosure are initially described in the context of wireless communications systems. Aspects of the disclosure are additionally illustrated by process flows. Aspects of the disclosure are further illustrated by and described with reference to apparatus diagrams, system diagrams, and flowcharts that relate to on-demand synchronization signaling for network energy savings systems.

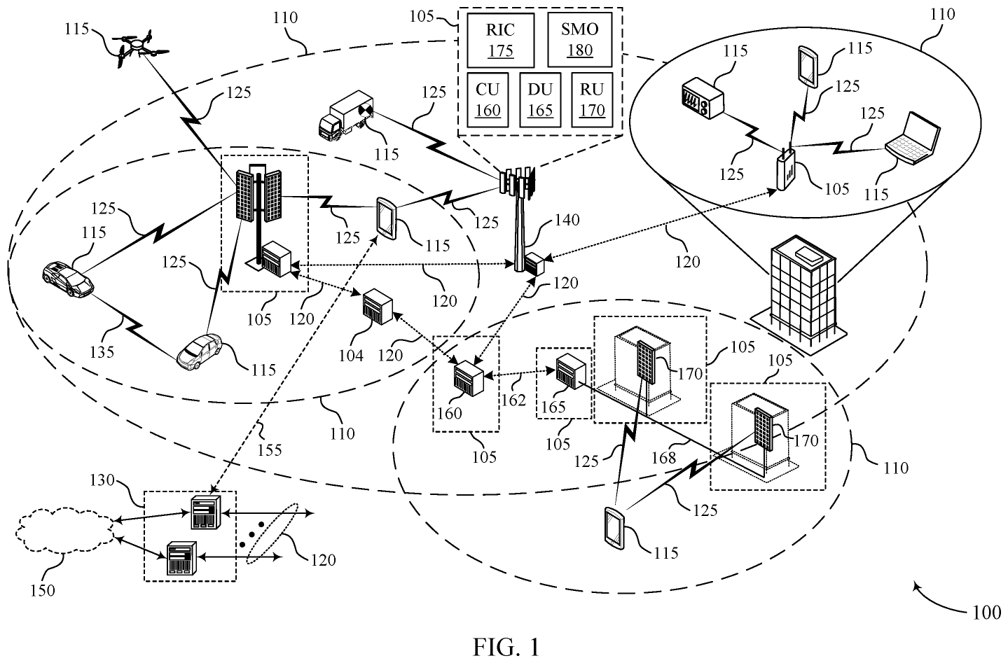

FIG. 1 shows an example of a wireless communications system 100 that supports on-demand synchronization signaling for network energy savings systems in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, a UE 115 may be in communications with a first network entity 105 associated with an NES cell and a second network entity 105 associated with an anchor cell. In some examples, the UE 115 may receive assistance information from the anchor cell (e.g., the second network entity 105) including an indication of one or more parameters for establishing communications with the NES cell (e.g., the first network entity 105). The UE 115 may receive a DL-RS from the NES cell that indicates first timing information (e.g., a portion of the one or more parameters) for establishing communications with the NES cell. In some cases, the DL-RS may be based on the assistance information. Responsive to receiving the DL-RS, the UE 115 may transmit a WUS to the NES cell including an indication of the first timing information. For example, the UE 115 may indicate a level associated with the first timing information. The NES cell may receive the WUS and determine second timing information (e.g., the remaining one or more parameters) based on the indication of the first timing information. Accordingly, the NES cell may transmit a timing information signal including an indication of the second timing information and a level associated with the second timing information to the UE 115.

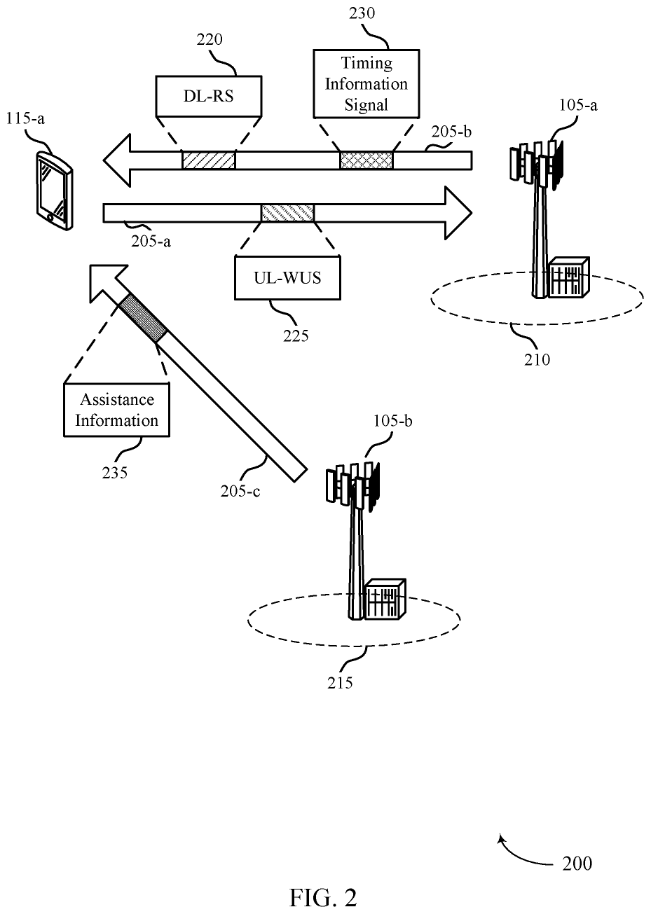

FIG. 2 shows an example of a wireless communications system 200 that supports on-demand synchronization signaling for network energy savings systems in accordance with one or more aspects of the present disclosure. The wireless communications system 200 may include a UE 115-a in communication with a first network entity 105-a and a second network entity 105-b, which may be examples of corresponding devices as described herein, including with reference to FIG. 1. The UE may communicate with the first network entity 105-a via wireless communication links 205-a and 205-b (e.g., a Uu link) and with the second network entity 105-b via wireless communication link 205-c. In some examples, wireless communication link 205-a may represent uplink communications between the UE 115-a and the first network entity 105-a, and wireless communication link 205-b may represent downlink communications between the UE 115-a and the first network entity 105-a. In some implementations there may be additional UEs 115 (not shown), additional first network entities 105-a (not shown), and additional second network entities 105-b (not shown) within the wireless communications system 200.

In some examples, the first network entity 105-a may transmit a synchronization signal block (SSB) to assist the UE 115-a in detecting and communicating with the first network entity 105-a. The SSB may be comprised of a primary synchronization signal (PSS), a secondary synchronization signal (SSS), and a physical broadcast channel (PBCH). The UE 115-a and the NES cell 210 may use the SSB for communication parameter acquisition (e.g., timing information, frequency, cell identifier (ID), beams), for signal quality measurement, for automatic gain control (AGC), for a time-frequency tracking loop, as a root quasi-colocation (QCL) source for other signals or channels, or any combination thereof.

Each network entity 105 may provide communication coverage to a coverage area. For example, the first network entity 105-a may be associated with or may represent a network energy savings (NES) cell 210, and the second network entity 105-b may be associated with or represent an anchor cell 215. In some examples where the first network entity 105-a represents a NES cell 210, the NES cell 210 (e.g., the first network entity 105-a) may support communication of light or on-demand SSBs for cell acquisition signaling. For example, the NES cell 210 may transmit an SSB using fewer resources relative to the second network entity 105-b that is not associated with the NES cell 210. Additionally, the NES cell 210 may transmit an SSB on-demand (e.g., aperiodically), which may support improved flexibility of resource utilization by the NES cell 210.

The NES cell 210 may transmit cell acquisition signaling to the UE 115-a to facilitate detection and measurement of the NES cell 210. In some examples, the cell acquisition signaling may include a downlink reference signal (DL-RS) 220 (e.g., a first signal) that may be lighter (e.g., use fewer resources) than an SSB. The DL-RS 220 may not carry all of the information (e.g., all of the communication parameters) included in an SSB. For example, the DL-RS may include partial information of the SSB. The UE 115-a may use the DL-RS 220 to acquire a symbol boundary, a portion of a cell ID associated with the NES cell 210, or both. The UE 115-a may acquire remaining information (e.g., remaining communication parameters) through additional cell acquisition signaling from the NES cell 210, the anchor cell 215, or both. For example, the UE 115-a may transmit an uplink WUS (UL-WUS) 225 to the NES cell 210 in response to receiving the DL-RS 220. The NES cell 210 may operate in a low-power state after transmitting the DL-RS 220, and the UL-WUS 225 may trigger the NES cell 210 to transmit the remaining information to the UE 115-a via a timing information signal 230 (e.g., a second signal of the cell acquisition signaling). The NES cell 210 may exit the low-power state after receiving the UL-WUS 225 to transmit the timing information signal 230.

Additionally, or alternatively, the UE 115-a may receive assistance information 235 from the anchor cell 215 including some or all of the remaining information. The UE 115-a may receive the assistance information 235 before receiving the DL-RS 220. In some examples, the assistance information 235 may indicate a distribution of the timing information (e.g., a set of communication parameters) across the cell acquisition signaling (e.g., the DL-RS 220 and the timing information signal 230) transmitted by the NES cell 210. For example, the assistance information may include partial information (e.g., a first subset of the set of communication parameters). Accordingly, the UE 115-a may determine that the remaining information (e.g., a second subset of the set of communication parameters) will be included in the cell acquisition signaling transmitted by the NES cell 210.

In some examples, the DL-RS 220 may be a combined PSS and SSS. The remaining information (e.g., the PBCH) may be transmitted without including the PSS or the SSS. For example, the DL-RS may have the combined PSS and SSS without being accompanied by PBCH, and the timing information signal 230 may be a standalone PBCH (e.g., not accompanied by a PSS or an SSS). The NES cell 210 may transmit the timing information signal 230 via preconfigured resources. Alternatively, the anchor cell 215 may indicate a set of resources for the NES cell 210 to use to transmit the timing information signal 230.

Alternatively, the DL-RS 220 may be a PSS. The remaining information (e.g., the SSS and PBCH) may be transmitted without including the PSS. For example, the DL-RS 220 may include the PSS without being accompanied by the SSS or PBCH, and the timing information signal 230 may be a combined SSS and PBCH. The NES cell 210 may transmit the timing information signal 230 via preconfigured resources. Alternatively, the anchor cell 215 may indicate a set of resources for the NES cell 210 to use to transmit the timing information signal 230. From the PSS, the UE 115-a may acquire a symbol boundary to receive the timing information signal 230.

Alternatively, the DL-RS 220 may be an SSS. The remaining information (e.g., the PSS and PBCH) may be transmitted without including the SSS. For example, the timing information signal 230 may be a combined SSS and PBCH. Transmitting the timing information signal 230 including a PSS may provide more flexible resource allocation for the timing information signal 230. For example, the NES cell 210 may transmit the PSS as a preamble of the timing information signal 230, and the UE 115-a may use the preamble (e.g., the PSS) to search for the timing information signal 230. The UE 115-a may acquire a symbol boundary to receive the timing information signal 230 from the anchor cell 215. For example, the UE 115-a may acquire the symbol boundary from the PSS of the anchor cell 215.

In some other examples, the DL-RS 220 may be a channel state information reference signal (CSI-RS) or a tracking reference signal (TRS). In some examples, the remaining information (e.g., a portion of a master information block (MIB) and a portion of the system information block (SIB)) may be included in a payload of a physical downlink shared channel (PDSCH). The information included in the PDSCH may be a minimum amount of info used by the UE 115-a to access the NES cell 210 or a minimum amount of information that is not already available at the UE 115-a. The NES cell 210 may transmit the timing information signal 230 including the PDSCH and a corresponding physical downlink control channel (PDCCH). The NES cell 210 may transmit the PDCCH via a preconfigured set of resources or via a set of resources indicated by the anchor cell 215. The UE 115-a may monitor for the PDCCH to determine communication resources for the PDSCH. In some other examples, the NES cell 210 may include the remaining information (e.g., minimum timing information, barring information, or both) in a short message carried by a PDCCH. In such examples, the NES cell 210 may transmit the timing information signal 230 comprising a PDCCH carrying a short message that includes the remaining information.

In some cases, the UE 115-a may acquire assistance information 235 from the anchor cell 215. The assistance information 235 may indicate a mode of operations supported by the NES cell 210, a set of configurations of the NES cell 210, or both. For example, the assistance information 235 may indicate one or more combinations of signal types for the cell acquisition signaling (e.g., the DL-RS 220 and the timing information signal 230) that are supported by the NES cell 210, as well as a set of configurations and resources corresponding to the one or more combinations of signal types. The set of configurations may comprise full information or partial information about a cell (e.g., ID information, timing information, frequency information, spatial information, cell barring information, a resource configuration, or any combination thereof), for the cell acquisition signaling (e.g., for the DL-RS 220 and the timing information signal 230).

The information communicated between the UE 115-a, the NES cell 210, and the anchor cell 215 may be beam specific. For example, the NES cell 210, the anchor cell 215, or both, may perform communications via multiple beams. In such examples, the partial information included in the assistance information 235, the remaining information included in the DL-RS 220, the timing information signal 230, or both, and the UL-WUS 225, may indicate different configurations for different beams of the NES cell 210, the anchor cell 215, or both.

In some cases where the set of configurations may only comprise partial information, the NES cell 210 may provide the remaining information to the UE 115-a. In some examples, based on the network deployment and the position of the UE 115-a within the wireless communications system 200, there may be a limited amount of candidate NES cells 210 around the UE 115-a. Accordingly, the DL-RS 220 or the timing information signal 230 may include partial cell ID information. For example, the DL-RS 220 or the timing information signal 230 may not carry all cell IDs (e.g., the 1008 cell IDs that may be indicated in an SSB) but may instead include fewer bits of cell ID information relative to an SSB (e.g., an index to a set of cell IDs that are available to the UE 115-a, the anchor cell 215, or both).

In some examples, there may be a level of synchronization between the NES cell 210 and the anchor cell 215. In such examples, there may be a minimum level of timing information for the UE 115-a to use to resolve ambiguity between signaling from the NES cell 210 and the anchor cell 215. The DL-RS 220 or the timing information signal 230 may carry this minimum level of timing information (e.g., fewer bits relative to an SSB). For example, the DL-RS 220 or the timing information signal 230 may include one or more least significant bits (LSBs) of a beam index, a half-frame index, or both, one or more LSBs of a system frame number, a symbol index within a slot, or an anchor cell timing delta value.

In some examples where the assistance information 235 indicates a set of configurations for additional cell acquisition signaling (e.g., the timing information signal 230, a random access channel, etc.), the DL-RS 220 or the timing information signal 230 may indicate an index to one of the configurations of the set of configurations. The UE 115-a may use the index to determine (e.g., identify) a format for the additional cell acquisition signaling and to receive the additional cell acquisition signaling.

In some implementations, the NES cell 210 may be in communications with the UE 115-a as well as additional UEs 115 (not shown). Some UEs 115 may receive a different level of assistance information 235 about the NES cell 210 from the anchor cell 215. For example, based on a capability of the UE 115-a, a level of coordination between the NES cell 210 and the anchor cell 215 (e.g., whether the NES cell 210 and the anchor cell 215 belong to a same DU/CU or different DUs/CUs), the relative locations of the UE 115-a, the NES cell 210, and the anchor cell 215 within the wireless communications system 200, or any combination thereof, the anchor cell 215 may provide no assistance information 235, a minimum level of assistance information 235, or a higher level of assistance information 235 to the UE 115-a. In some cases where the level of assistance information 235 provided to the UE 115-a is available to the NES cell 210, the NES cell 210 may provide more efficient remaining info via the cell acquisition signaling (e.g., may exclude redundant information included in the assistance information 235). For example, the NES cell 210 may support indicating different levels of the remaining timing information in the timing information signal 230 based on the available information at the UE 115-a.

The UE 115-a may indicate the information available at the UE 115-a, the remaining information, or both, via the UL-WUS 225. The UE 115-a may indicate the information explicitly or implicitly. For example, the UE 115-a may be preconfigured with N levels of information, and the UE may explicitly indicate, to the NES cell 210 via the UL-WUS 225, an index to the relevant (e.g., first) level of information. Alternatively, the anchor cell 215 may indicate the level of information the UE 115-a should request (e.g., explicitly) from the NES cell 210. The anchor cell may transparently (e.g., implicitly) indicate the level of information by providing the UE 115-a with a configuration and resources for transmitting the UL-WUS 225 that are selected by the anchor cell 215 to represent the level of information. In some other examples, the UE 115-a may implicitly indicate the level of information via the resources over which the UE 115-a transmits the UL-WUS 225, or via one or more elements of the UL-WUS 225 (e.g., a scrambling ID, a preamble ID, a cyclic shift value, a payload of another message sent by the UE 115-a, including a scheduling request (SR), a physical uplink control channel (PUCCH), or a physical uplink shared channel (PUSCH)).

In some implementations, the NES cell 210 may be in communications with the UE 115-a as well as additional UEs 115 (not shown). Some UEs 115 may be provided with a different level of assistance information 235 and may wake up the NES cell 210 to request different (e.g., second) levels of remaining timing information. The NES cell 210 may support indicating the level of information included in the timing information signal 230 so the UE 115 receiving the timing information signal 230 understands how to interpret and decode the timing information signal 230. For example, the NES cell 210 may indicate a second level (e.g., one of N levels) of information provided in the timing information signal 230. The timing information signal 230 may carry the indication via a header in the payload of the timing information signal 230, a flag in a PDCCH associated with the timing information signal 230, a scrambling ID, a demodulation reference signal (DMRS) associated with the timing information signal 230, or any combination thereof. Alternatively, the timing information signal 230 may implicitly indicate the second level of information via the time-frequency resources used to transmit the timing information signal 230. In some cases, the NES cell 210 may transmit multiple (e.g., hierarchical) timing information signals 230. In such cases, the NES cell 210 may transmit a first timing information signal 230 including minimal information, information about a second timing information signal 230 (not shown) that carries additional information, or both.

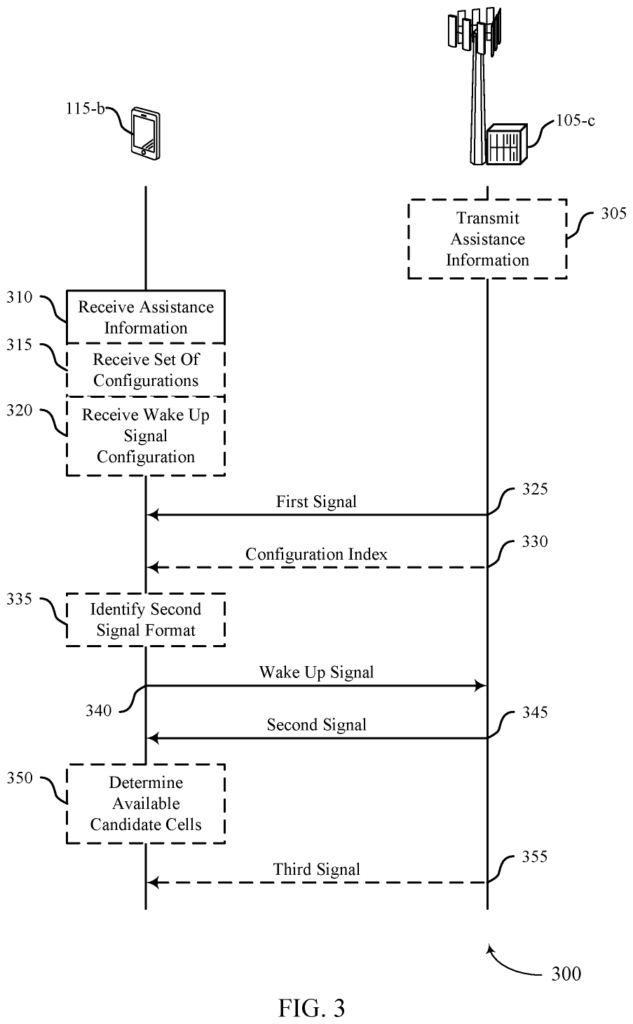

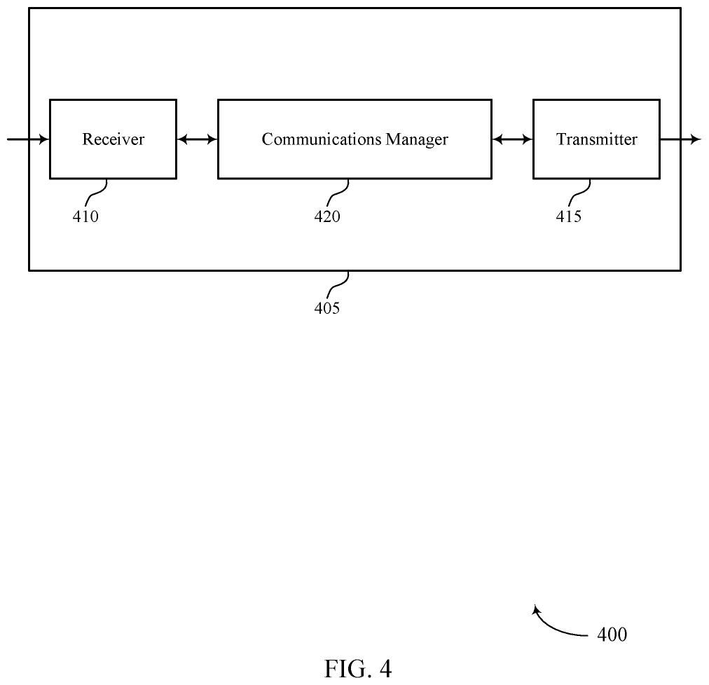

FIG. 3 shows an example of a process flow 300 that supports on-demand synchronization signaling for network energy savings systems in accordance with one or more aspects of the present disclosure. The process flow 300 may implement or be implemented by aspects of the wireless communications system 100 and the wireless communications system 200, as described with reference to FIGS. 1 and 2. For instance, in the example of FIG. 4, a UE 115-b may be in communication with a network entity 105-c, which may be examples of devices described herein with reference to FIG. 1 or FIG. 2. In the following description of the process flow 300, the operations between the UE 115-b and the network entity 105-c may be performed in a different order than the example shown, or the operations between the UE 115-b and the network entity 105-c may be performed in different orders at different times. Some operations may also be omitted from the process flow 300, and other operations may be added to the process flow 300.

At 305, the network entity 105-c may transmit assistance information for detecting the network entity 105-c. In some examples, the assistance information may include an indication of a distribution of a set of parameters across cell acquisition signaling transmitted from the network entity 105-c. Wireless devices (e.g., the UE 115-b) may use the set of parameters for communicating with the network entity 105-c. The set of parameters may include an index for a set of cell IDs, one or more least significant bits of a beam index, a half-frame index, one or more least significant bits of a system frame number, a symbol index, or an anchor cell timing delta value, an index for a configuration of a set of configurations, or any combination thereof. In some examples, the network entity 105-c may share the assistance information with an anchor cell (not shown), which may transmit the assistance information to UE 115-b. The network entity 105-c may be associated with one or more NES cells.

At 310, the UE 115-b may receive the assistance information for detecting the network entity 105-c. The assistance information may include the indication of the distribution of the set of parameters across the cell acquisition signaling for the network entity. The UE 115-b may use the set of parameters for communicating with the network entity 105-c. In some examples, the UE 115-b may receive the assistance information from the anchor cell.

At 315, the UE 115-b may receive, from the anchor cell, an indication of a set of configurations for one or more signals communicated by the network entity 105-c. The set of configurations may include a cell ID, timing information, frequency information, spatial information, beam information, cell barring information, a resource configuration, or any combination thereof. In some examples, the one or more signals may include the second signal of the cell acquisition signaling. At 320, the UE 115-b may receive, from the anchor cell, an indication of a configuration for transmitting a wake up signal. The configuration may indicate resources associated with a first level of information associated with a first subset of the set of parameters. In some examples, the anchor cell may include the indication of the set of configurations for the one or more signals communicated by the network entity 105-c and the indication of the configuration for transmitting the wake up signal in the assistance information.

At 325, the network entity 105-c may transmit, to the UE 115-b, a first signal of the cell acquisition signaling including a first indication of the first subset of the set of parameters. In some examples, the first signal may be a primary synchronization signal (PSS), a secondary synchronization signal (SSS), a combined PSS and SSS, a CSI-RS, or a TRS.

At 330, the network entity 105-c may transmit, to the UE 115-b, an indication of an index for a configuration of the set of configurations for the one or more signals communicated by the network entity 105-c. In some examples, the network entity 105-c may include the indication in the first signal of the cell acquisition signaling. The set of configurations may include a cell ID, timing information, frequency information, spatial information, beam information, cell barring information, a resource configuration, or any combination thereof. The network entity 105-c may transmit a signal of the one or more signals in accordance with the configuration of the set of configurations. For example, the network entity 105-c may transmit a second signal of the one or more signals in accordance with the configuration.

At 335, the UE 115-b may identify a format of the second signal based on the index for the configuration of the set of configurations for the one or more signals communicated by the network entity 105-c (e.g., via the first signal). In some examples, the UE 115-b may receive the second signal in accordance with the configuration of the set of configurations and based on identifying the format of the second signal.

At 340, the UE 115-b may transmit a wake up signal to the network entity 105-c based on receiving the first signal. In some examples, the UE 115-b may transmit, via the resources indicated in the configuration for transmitting the wake up signal, an indication of the first level of information based on receiving the indication. For example, the UE 115-b may transmit the indication of the first level of information via a scrambling ID of the wake up signal, a preamble ID of the wake up signal, a cyclic shift value of the wake up signal, a message payload transmitted by the UE 115-b (e.g., of a SR, a PUCCH, or a PUSCH), or any combination thereof. In some examples, the UE 115-b may transmit an indication of an index for the first level of information associated with the first subset of the set of parameters in the wake up signal. In some examples, the first level of information may be preconfigured at the UE 115-b. The first level of information may be based on the first signal of the cell acquisition signaling including the first indication of the first subset of the set of parameters.

At 345, the network entity 105-c may transmit, to the UE 115-b based on receiving the wake up signal, the second signal of the cell acquisition signaling including a second indication of a second subset of the set of parameters. In some examples where the first signal is a PSS, the second signal may be a combined SSS and PBCH. In some other examples where the first signal is an SSS, the second signal may be a combined PSS and PBCH. In some other examples where the first signal is a combined PSS and SSS, the second signal may be a standalone PBCH. Alternatively, if the first signal is a CSI-RS or a TRS, the second signal may be a combined PDCCH and a PDSCH carrying partial MIB and SIB information or a non-scheduling PDCCH.

The network entity 105-c may include an indication of a second level of information associated with the second signal and the second subset of the set of parameters in the second signal based on receiving the wake up signal from the UE 115-b. The UE 115-b may receive the indication of the second level of information associated with the second signal and the second subset of the set of parameters based on transmitting the wake up signal to the network entity 105-c. In some examples, the UE 115-b may receive the indication via a header in a payload of the second signal, a flag in a PDCCH associated with the second signal, a scrambling ID, a DMRS associated with the second signal, time and frequency resources associated with receiving the second signal, or any combination thereof.

At 350, the UE 115-b may determine, based on the index for the set of cell IDs, one or more candidate cells (e.g., NES cells) available for communications with the anchor cell, the UE 115-b, or both. In some examples, at least one of the one or more candidate cells may be associated with the network entity 105-c.

At 355, the network entity 105-c may transmit, to the UE 115-b and based on transmitting the second signal, a third signal of the cell acquisition signaling including a third subset of the set of parameters. In some examples, the second signal may include information associated with the third signal, and the UE 115-b may receive the third signal based on receiving the second signal.

FIG. 4 shows a block diagram 400 of a device 405 that supports on-demand synchronization signaling for network energy savings systems in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to on-demand synchronization signaling for network energy savings systems). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to on-demand synchronization signaling for network energy savings systems). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of on-demand synchronization signaling for network energy savings systems as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

For example, the communications manager 420 is capable of, configured to, or operable to support a means for receiving assistance information for detecting a network entity, the assistance information including an indication of a distribution of a set of parameters across cell acquisition signaling for the network entity, the set of parameters for communicating with the network entity. The communications manager 420 is capable of, configured to, or operable to support a means for receiving, from the network entity, a first signal of the cell acquisition signaling including a first indication of a first subset of the set of parameters. The communications manager 420 is capable of, configured to, or operable to support a means for transmitting a wake up signal to the network entity based on receiving the first signal. The communications manager 420 is capable of, configured to, or operable to support a means for receiving, from the network entity based on transmitting the wake up signal, a second signal of the cell acquisition signaling including a second indication of a second subset of the set of parameters.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for reduced power consumption and more efficient utilization of communication resources.

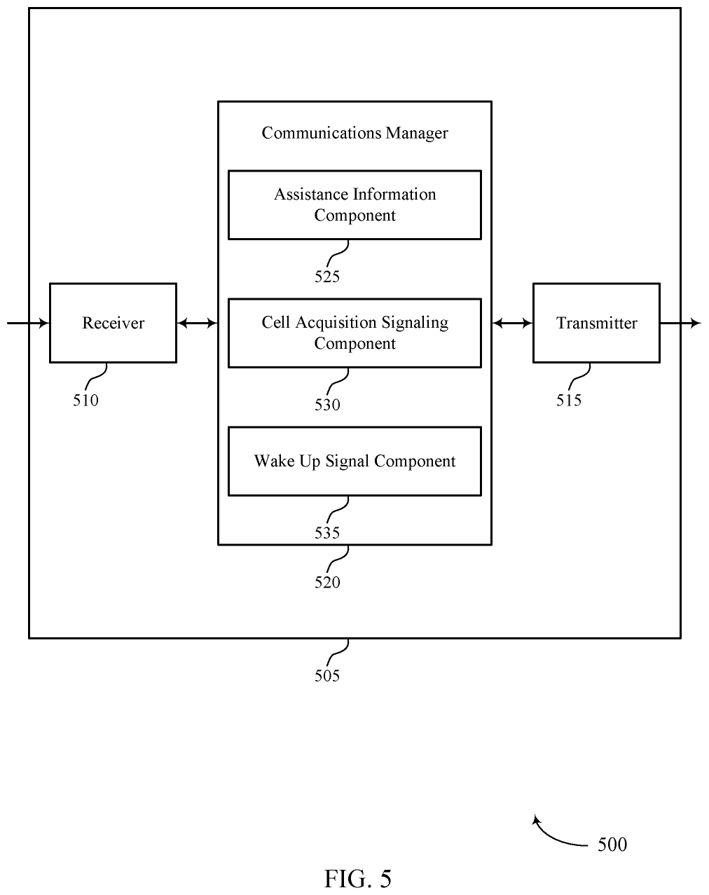

FIG. 5 shows a block diagram 500 of a device 505 that supports on-demand synchronization signaling for network energy savings systems in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to on-demand synchronization signaling for network energy savings systems). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to on-demand synchronization signaling for network energy savings systems). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of on-demand synchronization signaling for network energy savings systems as described herein. For example, the communications manager 520 may include an assistance information component 525, a cell acquisition signaling component 530, a wake up signal component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The assistance information component 525 is capable of, configured to, or operable to support a means for receiving assistance information for detecting a network entity, the assistance information including an indication of a distribution of a set of parameters across cell acquisition signaling for the network entity, the set of parameters for communicating with the network entity. The cell acquisition signaling component 530 is capable of, configured to, or operable to support a means for receiving, from the network entity, a first signal of the cell acquisition signaling including a first indication of a first subset of the set of parameters. The wake up signal component 535 is capable of, configured to, or operable to support a means for transmitting a wake up signal to the network entity based on receiving the first signal. The cell acquisition signaling component 530 is capable of, configured to, or operable to support a means for receiving, from the network entity based on transmitting the wake up signal, a second signal of the cell acquisition signaling including a second indication of a second subset of the set of parameters.

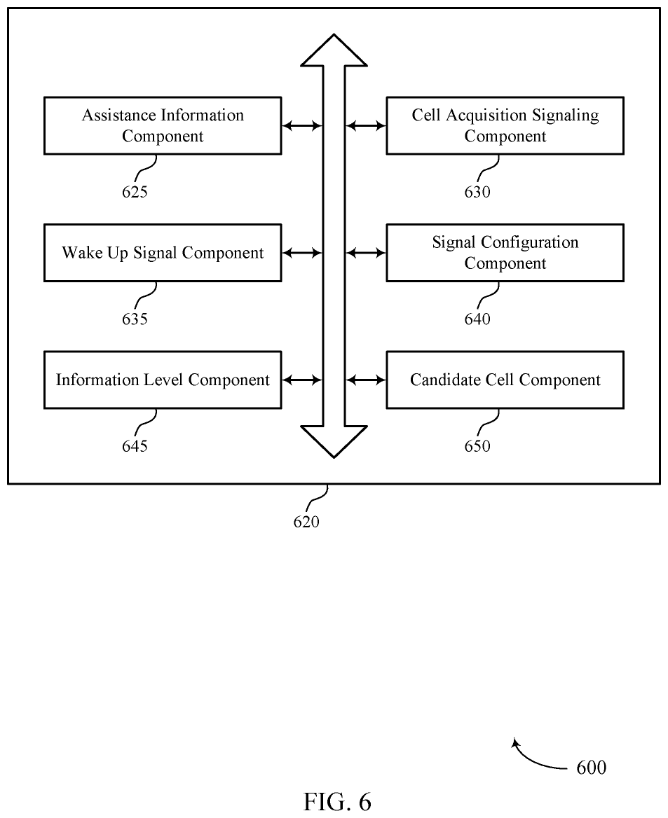

FIG. 6 shows a block diagram 600 of a communications manager 620 that supports on-demand synchronization signaling for network energy savings systems in accordance with one or more aspects of the present disclosure. The communications manager 620 may be an example of aspects of a communications manager 420, a communications manager 520, or both, as described herein. The communications manager 620, or various components thereof, may be an example of means for performing various aspects of on-demand synchronization signaling for network energy savings systems as described herein. For example, the communications manager 620 may include an assistance information component 625, a cell acquisition signaling component 630, a wake up signal component 635, a signal configuration component 640, an information level component 645, a candidate cell component 650, or any combination thereof. Each of these components, or components or subcomponents thereof (e.g., one or more processors, one or more memories), may communicate, directly or indirectly, with one another (e.g., via one or more buses).

The assistance information component 625 is capable of, configured to, or operable to support a means for receiving assistance information for detecting a network entity, the assistance information including an indication of a distribution of a set of parameters across cell acquisition signaling for the network entity, the set of parameters for communicating with the network entity. The cell acquisition signaling component 630 is capable of, configured to, or operable to support a means for receiving, from the network entity, a first signal of the cell acquisition signaling including a first indication of a first subset of the set of parameters. The wake up signal component 635 is capable of, configured to, or operable to support a means for transmitting a wake up signal to the network entity based on receiving the first signal. In some examples, the cell acquisition signaling component 630 is capable of, configured to, or operable to support a means for receiving, from the network entity based on transmitting the wake up signal, a second signal of the cell acquisition signaling including a second indication of a second subset of the set of parameters.

In some examples, the first signal includes an PSS, and the second signal includes an SSS and a physical broadcast channel (PBCH).

In some examples, the first signal includes an SSS, and the second signal includes an PSS and a physical broadcast channel (PBCH).

In some examples, the first signal includes an PSS and an SSS and the second signal includes a standalone physical broadcast channel (PBCH).

In some examples, the first signal includes a channel state information reference signal (CSI-RS) or a tracking reference signal (TRS) and the second signal includes a PDCCH and an PDSCH carrying partial master information block (MIB) and SIB information or a non-scheduling PDCCH.

In some examples, the set of parameters include an index for a set of cell identifiers (IDs), one or more least significant bits of a beam index, a half-frame index, one or more least significant bits of a system frame number, a symbol index, or an anchor cell timing delta value, an index for a configuration of a set of configurations, or any combination thereof.

In some examples, the candidate cell component 650 is capable of, configured to, or operable to support a means for determining, based on the index for the set of cell IDs, one or more candidate cells available for communications with an anchor cell, the UE, or both, where at least one of the one or more candidate cells is associated with the network entity.

In some examples, the signal configuration component 640 is capable of, configured to, or operable to support a means for receiving, from an anchor cell, an indication of a set of configurations for one or more signals communicated by the network entity, the set of configurations including a cell identifier, timing information, frequency information, spatial information, beam information, cell barring information, a resource configuration, or any combination thereof.

In some examples, the signal configuration component 640 is capable of, configured to, or operable to support a means for receiving, from the network entity, an indication of an index for a configuration of the set of configurations. In some examples, the signal configuration component 640 is capable of, configured to, or operable to support a means for identifying a format of the second signal based on the index, where the UE receives the second signal in accordance with the configuration of the set of configurations and based on identifying the format of the second signal.

In some examples, the one or more signals include the second signal of the cell acquisition signaling.

In some examples, the signal configuration component 640 is capable of, configured to, or operable to support a means for receiving, from an anchor cell, an indication of a configuration for transmitting the wake up signal, the configuration indicating resources associated with a first level of information associated with the first subset of the set of parameters. In some examples, the information level component 645 is capable of, configured to, or operable to support a means for transmitting, via the resources indicated in the configuration, an indication of the first level of information based on receiving the indication, where the first level of information is based on the first signal of the cell acquisition signaling including the first indication of the first subset of the set of parameters.

In some examples, the UE transmits the indication of the first level of information via the wake up signal, the indication included in a scrambling identifier of the wake up signal, a preamble identifier of the wake up signal, a cyclic shift value of the wake up signal, a message payload transmitted by the UE, or any combination thereof.

In some examples, to support transmitting the wake up signal, the wake up signal component 635 is capable of, configured to, or operable to support a means for transmitting an indication of an index for a first level of information associated with the first subset of the set of parameters, where the first level of information is preconfigured at the UE.

In some examples, to support receiving the second signal, the cell acquisition signaling component 630 is capable of, configured to, or operable to support a means for receiving an indication of a second level of information associated with the second signal and the second subset of the set of parameters based on transmitting the wake up signal to the network entity.

In some examples, the UE receives the indication via a header in a payload of the second signal, a flag in a physical downlink control channel associated with the second signal, a scrambling identifier, a demodulation reference signal associated with the second signal, time and frequency resources associated with receiving the second signal, or any combination thereof.

In some examples, the cell acquisition signaling component 630 is capable of, configured to, or operable to support a means for receiving, from the network entity and based on receiving the second signal, a third signal of the cell acquisition signaling including a third subset of the set of parameters.

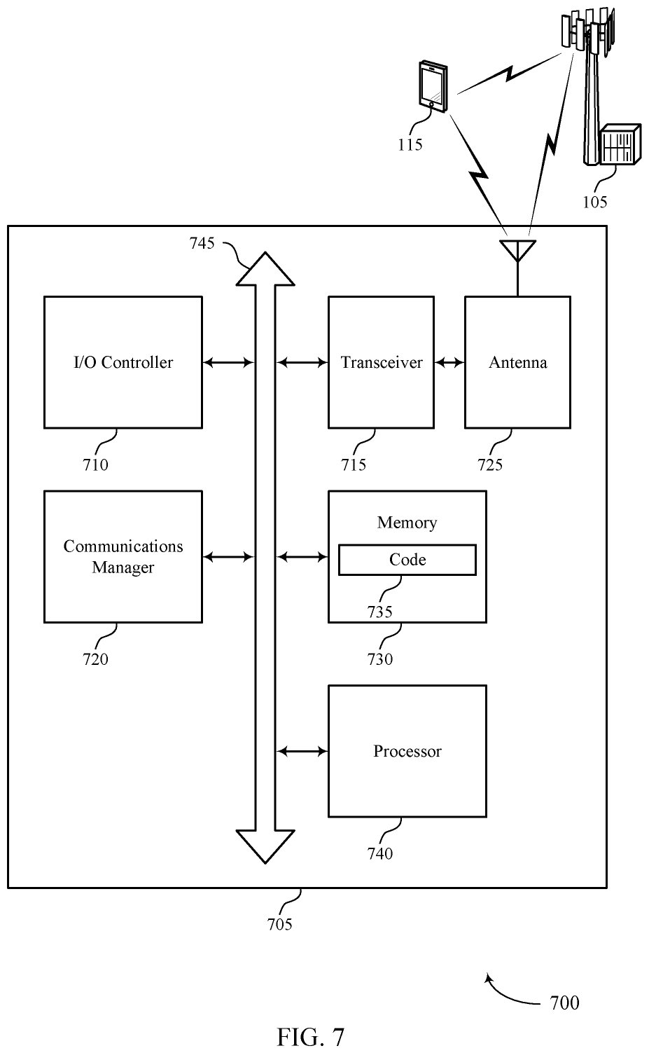

FIG. 7 shows a diagram of a system 700 including a device 705 that supports on-demand synchronization signaling for network energy savings systems in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting on-demand synchronization signaling for network energy savings systems). For example, the device 705 or a component of the device 705 may include at least one processor 740 and at least one memory 730 coupled with or to the at least one processor 740, the at least one processor 740 and the at least one memory 730 configured to perform various functions described herein. In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

For example, the communications manager 720 is capable of, configured to, or operable to support a means for receiving assistance information for detecting a network entity, the assistance information including an indication of a distribution of a set of parameters across cell acquisition signaling for the network entity, the set of parameters for communicating with the network entity. The communications manager 720 is capable of, configured to, or operable to support a means for receiving, from the network entity, a first signal of the cell acquisition signaling including a first indication of a first subset of the set of parameters. The communications manager 720 is capable of, configured to, or operable to support a means for transmitting a wake up signal to the network entity based on receiving the first signal. The communications manager 720 is capable of, configured to, or operable to support a means for receiving, from the network entity based on transmitting the wake up signal, a second signal of the cell acquisition signaling including a second indication of a second subset of the set of parameters.

By including or configuring the communications manager 720 in accordance with examples as described herein, the device 705 may support techniques for reduced latency and improved user experience related to reduced power consumption and more efficient utilization of communication resources.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of on-demand synchronization signaling for network energy savings systems as described herein, or the at least one processor 740 and the at least one memory 730 may be otherwise configured to, individually or collectively, perform or support such operations.

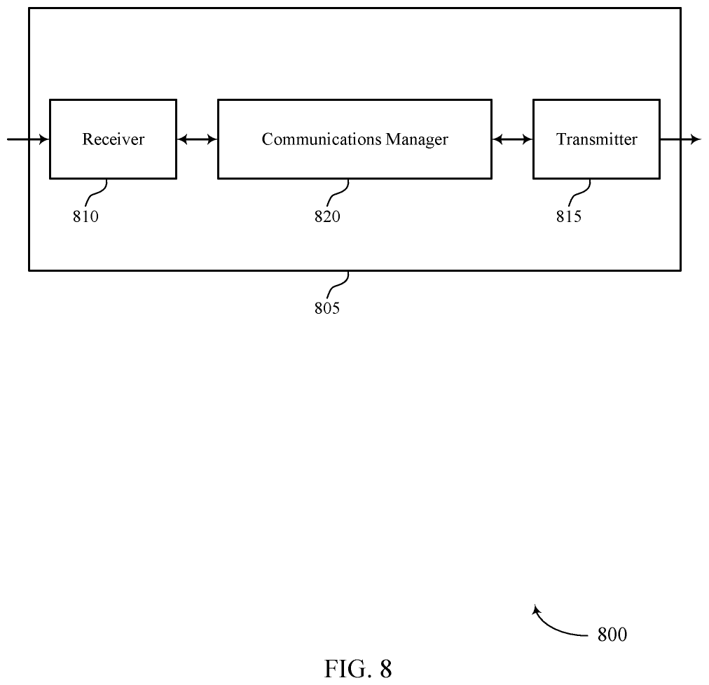

FIG. 8 shows a block diagram 800 of a device 805 that supports on-demand synchronization signaling for network energy savings systems in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations or components thereof may be examples of means for performing various aspects of on-demand synchronization signaling for network energy savings systems as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

For example, the communications manager 820 is capable of, configured to, or operable to support a means for transmitting assistance information for detecting the network entity, the assistance information including an indication of a distribution of a set of parameters across cell acquisition signaling transmitted from the network entity, the set of parameters for communicating with the network entity. The communications manager 820 is capable of, configured to, or operable to support a means for transmitting, to a UE, a first signal of the cell acquisition signaling including a first indication of a first subset of the set of parameters. The communications manager 820 is capable of, configured to, or operable to support a means for receiving a wake up signal from the UE based on transmitting the first signal. The communications manager 820 is capable of, configured to, or operable to support a means for transmitting, to the UE based on receiving the wake up signal, a second signal of the cell acquisition signaling including a second indication of a second subset of the set of parameters.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced power consumption and more efficient utilization of communication resources.

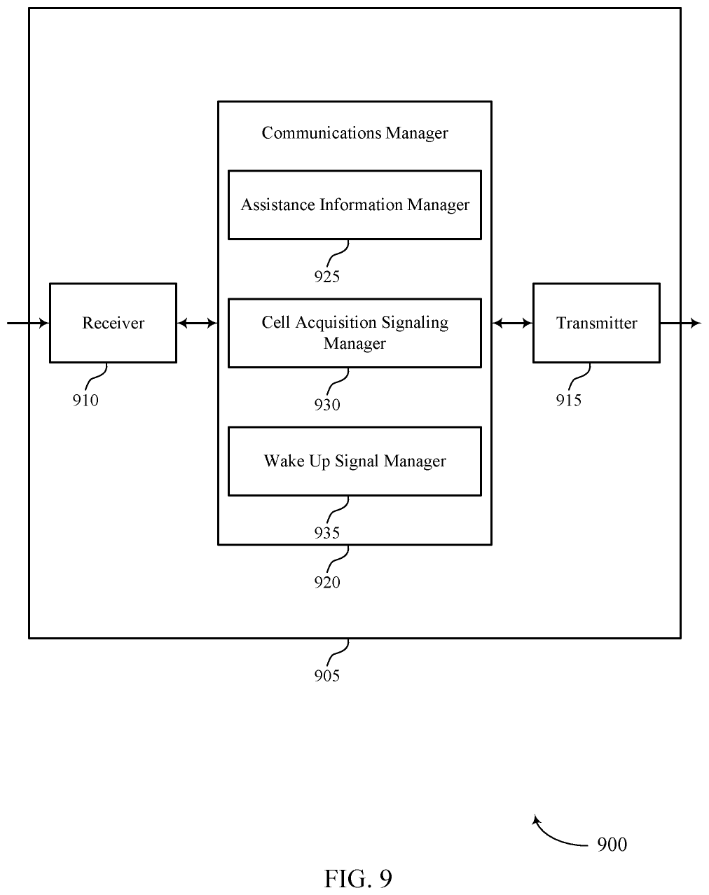

FIG. 9 shows a block diagram 900 of a device 905 that supports on-demand synchronization signaling for network energy savings systems in accordance with one or more aspects of the present disclosure. The device 905 may be an example of aspects of a device 805 or a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of on-demand synchronization signaling for network energy savings systems as described herein. For example, the communications manager 920 may include an assistance information manager 925, a cell acquisition signaling manager 930, a wake up signal manager 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The assistance information manager 925 is capable of, configured to, or operable to support a means for transmitting assistance information for detecting the network entity, the assistance information including an indication of a distribution of a set of parameters across cell acquisition signaling transmitted from the network entity, the set of parameters for communicating with the network entity. The cell acquisition signaling manager 930 is capable of, configured to, or operable to support a means for transmitting, to a UE, a first signal of the cell acquisition signaling including a first indication of a first subset of the set of parameters. The wake up signal manager 935 is capable of, configured to, or operable to support a means for receiving a wake up signal from the UE based on transmitting the first signal. The cell acquisition signaling manager 930 is capable of, configured to, or operable to support a means for transmitting, to the UE based on receiving the wake up signal, a second signal of the cell acquisition signaling including a second indication of a second subset of the set of parameters.

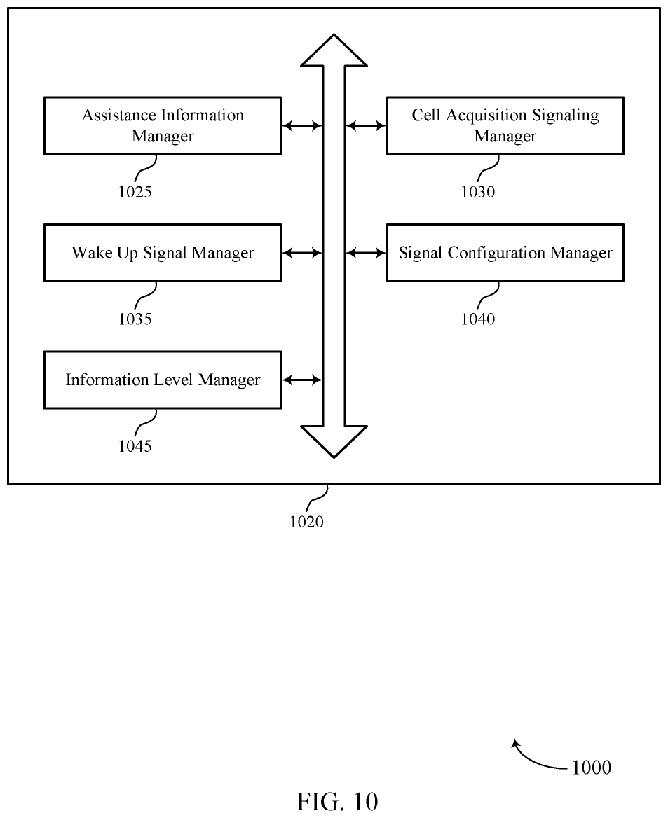

FIG. 10 shows a block diagram 1000 of a communications manager 1020 that supports on-demand synchronization signaling for network energy savings systems in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of on-demand synchronization signaling for network energy savings systems as described herein. For example, the communications manager 1020 may include an assistance information manager 1025, a cell acquisition signaling manager 1030, a wake up signal manager 1035, a signal configuration manager 1040, an information level manager 1045, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The assistance information manager 1025 is capable of, configured to, or operable to support a means for transmitting assistance information for detecting the network entity, the assistance information including an indication of a distribution of a set of parameters across cell acquisition signaling transmitted from the network entity, the set of parameters for communicating with the network entity. The cell acquisition signaling manager 1030 is capable of, configured to, or operable to support a means for transmitting, to a UE, a first signal of the cell acquisition signaling including a first indication of a first subset of the set of parameters. The wake up signal manager 1035 is capable of, configured to, or operable to support a means for receiving a wake up signal from the UE based on transmitting the first signal. In some examples, the cell acquisition signaling manager 1030 is capable of, configured to, or operable to support a means for transmitting, to the UE based on receiving the wake up signal, a second signal of the cell acquisition signaling including a second indication of a second subset of the set of parameters.

In some examples, the first signal includes an PSS, and the second signal includes an SSS and a physical broadcast channel (PBCH).

In some examples, the first signal includes an SSS, and the second signal includes an PSS and a physical broadcast channel (PBCH).

In some examples, the first signal includes an PSS and an SSS and the second signal includes a standalone physical broadcast channel (PBCH).

In some examples, the first signal includes a channel state information reference signal (CSI-RS) or a tracking reference signal (TRS) and the second signal includes a PDCCH and an PDSCH carrying partial master information block (MIB) and SIB information or a non-scheduling PDCCH.

In some examples, the set of parameters include an index for a set of cell identifiers (IDs), one or more least significant bits of a beam index, a half-frame index, one or more least significant bits of a system frame number, a symbol index, or an anchor cell timing delta value, an index for a configuration of a set of configurations, or any combination thereof.

In some examples, the signal configuration manager 1040 is capable of, configured to, or operable to support a means for transmitting, to the UE, an indication of an index for a configuration of a set of configurations for one or more signals communicated by the network entity, the set of configurations including a cell identifier, timing information, frequency information, spatial information, beam information, cell barring information, a resource configuration, or any combination thereof. In some examples, the cell acquisition signaling manager 1030 is capable of, configured to, or operable to support a means for transmitting a signal of the one or more signals in accordance with the configuration of the set of configurations.

In some examples, the information level manager 1045 is capable of, configured to, or operable to support a means for receiving, via a set of resources and based on transmitting the first signal, an indication of a first level of information, where the first level of information is based on the first signal including the first indication of the first subset of the set of parameters.

In some examples, to support receiving the wake up signal, the wake up signal manager 1035 is capable of, configured to, or operable to support a means for receiving an indication of an index for a first level of information associated with the first subset of the set of parameters, where the first level of information is preconfigured at the UE.

In some examples, to support transmitting the second signal, the cell acquisition signaling manager 1030 is capable of, configured to, or operable to support a means for transmitting an indication of a second level of information associated with the second signal and the second subset of the set of parameters based on receiving the wake up signal from the UE.

In some examples, the cell acquisition signaling manager 1030 is capable of, configured to, or operable to support a means for transmitting, to the UE and based on transmitting the second signal, a third signal of the cell acquisition signaling including a third subset of the set of parameters.

In some examples, the network entity is associated with one or more network energy savings (NES) cells.

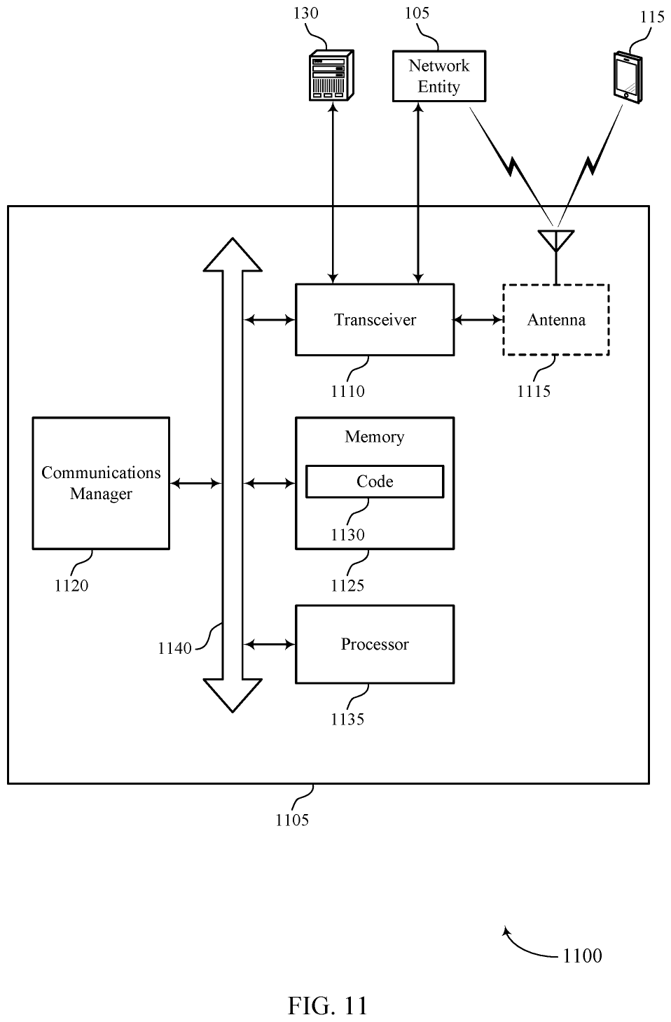

FIG. 11 shows a diagram of a system 1100 including a device 1105 that supports on-demand synchronization signaling for network energy savings systems in accordance with one or more aspects of the present disclosure. The device 1105 may be an example of or include components of a device 805, a device 905, or a network entity 105 as described herein. The device 1105 may communicate with other network devices or network equipment such as one or more of the network entities 105, UEs 115, or any combination thereof. The communications may include communications over one or more wired interfaces, over one or more wireless interfaces, or any combination thereof. The device 1105 may include components that support outputting and obtaining communications, such as a communications manager 1120, a transceiver 1110, one or more antennas 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., communication link(s) 125, backhaul communication link(s) 120, a midhaul communication link 162, a fronthaul communication link 168).

The at least one memory 1125 may include RAM, ROM, or any combination thereof. The at least one memory 1125 may store computer-readable, computer-executable, or processor-executable code, such as the code 1130. The code 1130 may include instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may include, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting on-demand synchronization signaling for network energy savings systems). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125). In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with one or more other network entities 105, and may include a controller or scheduler for controlling communications with UEs 115 (e.g., in cooperation with the one or more other network devices). In some examples, the communications manager 1120 may support an X2 interface within an LTE/LTE-A wireless communications network technology to provide communication between network entities 105.

For example, the communications manager 1120 is capable of, configured to, or operable to support a means for transmitting assistance information for detecting the network entity, the assistance information including an indication of a distribution of a set of parameters across cell acquisition signaling transmitted from the network entity, the set of parameters for communicating with the network entity. The communications manager 1120 is capable of, configured to, or operable to support a means for transmitting, to a UE, a first signal of the cell acquisition signaling including a first indication of a first subset of the set of parameters. The communications manager 1120 is capable of, configured to, or operable to support a means for receiving a wake up signal from the UE based on transmitting the first signal. The communications manager 1120 is capable of, configured to, or operable to support a means for transmitting, to the UE based on receiving the wake up signal, a second signal of the cell acquisition signaling including a second indication of a second subset of the set of parameters.

By including or configuring the communications manager 1120 in accordance with examples as described herein, the device 1105 may support techniques for reduced latency and improved user experience related to reduced power consumption and more efficient utilization of communication resources.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of on-demand synchronization signaling for network energy savings systems as described herein, or the at least one processor 1135 and the at least one memory 1125 may be otherwise configured to, individually or collectively, perform or support such operations.

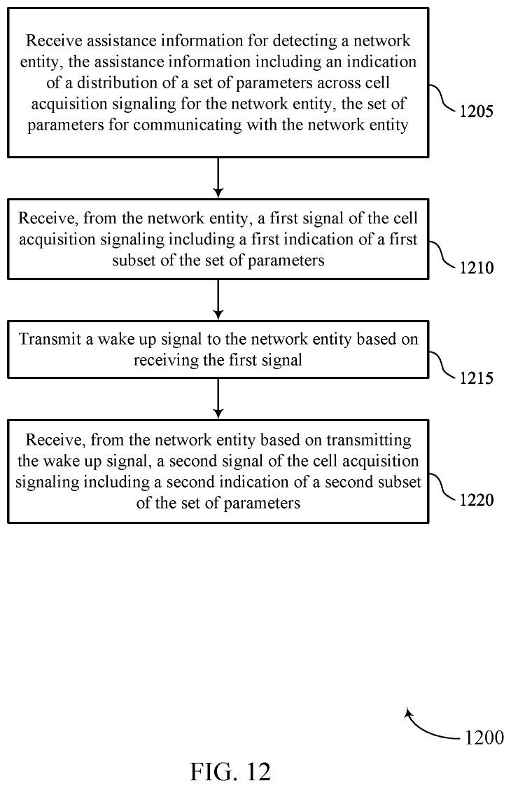

FIG. 12 shows a flowchart illustrating a method 1200 that supports on-demand synchronization signaling for network energy savings systems in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include receiving assistance information for detecting a network entity, the assistance information including an indication of a distribution of a set of parameters across cell acquisition signaling for the network entity, the set of parameters for communicating with the network entity. The operations of 1205 may be performed in accordance with examples as disclosed herein. In some examples, aspects of the operations of 1205 may be performed by an assistance information component 625 as described with reference to FIG. 6.

At 1210, the method may include receiving, from the network entity, a first signal of the cell acquisition signaling including a first indication of a first subset of the set of parameters. The operations of 1210 may be performed in accordance with examples as disclosed herein. In some examples, aspects of the operations of 1210 may be performed by a cell acquisition signaling component 630 as described with reference to FIG. 6.

At 1215, the method may include transmitting a wake up signal to the network entity based on receiving the first signal. The operations of 1215 may be performed in accordance with examples as disclosed herein. In some examples, aspects of the operations of 1215 may be performed by a wake up signal component 635 as described with reference to FIG. 6.

At 1220, the method may include receiving, from the network entity based on transmitting the wake up signal, a second signal of the cell acquisition signaling including a second indication of a second subset of the set of parameters. The operations of 1220 may be performed in accordance with examples as disclosed herein. In some examples, aspects of the operations of 1220 may be performed by a cell acquisition signaling component 630 as described with reference to FIG. 6.

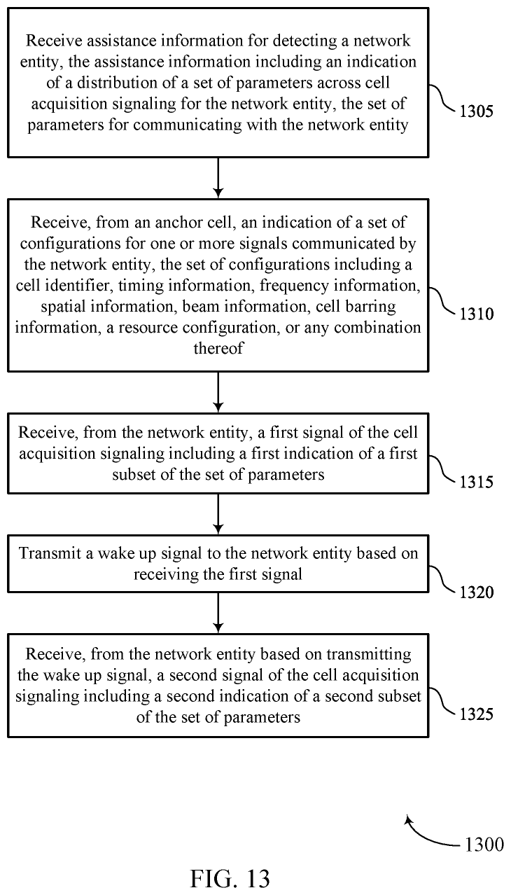

FIG. 13 shows a flowchart illustrating a method 1300 that supports on-demand synchronization signaling for network energy savings systems in accordance with one or more aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method may include receiving assistance information for detecting a network entity, the assistance information including an indication of a distribution of a set of parameters across cell acquisition signaling for the network entity, the set of parameters for communicating with the network entity. The operations of 1305 may be performed in accordance with examples as disclosed herein. In some examples, aspects of the operations of 1305 may be performed by an assistance information component 625 as described with reference to FIG. 6.

At 1310, the method may include receiving, from an anchor cell, an indication of a set of configurations for one or more signals communicated by the network entity, the set of configurations including a cell identifier, timing information, frequency information, spatial information, beam information, cell barring information, a resource configuration, or any combination thereof. The operations of 1310 may be performed in accordance with examples as disclosed herein. In some examples, aspects of the operations of 1310 may be performed by a signal configuration component 640 as described with reference to FIG. 6.

At 1315, the method may include receiving, from the network entity, a first signal of the cell acquisition signaling including a first indication of a first subset of the set of parameters. The operations of 1315 may be performed in accordance with examples as disclosed herein. In some examples, aspects of the operations of 1315 may be performed by a cell acquisition signaling component 630 as described with reference to FIG. 6.

At 1320, the method may include transmitting a wake up signal to the network entity based on receiving the first signal. The operations of 1320 may be performed in accordance with examples as disclosed herein. In some examples, aspects of the operations of 1320 may be performed by a wake up signal component 635 as described with reference to FIG. 6.

At 1325, the method may include receiving, from the network entity based on transmitting the wake up signal, a second signal of the cell acquisition signaling including a second indication of a second subset of the set of parameters. The operations of 1325 may be performed in accordance with examples as disclosed herein. In some examples, aspects of the operations of 1325 may be performed by a cell acquisition signaling component 630 as described with reference to FIG. 6.

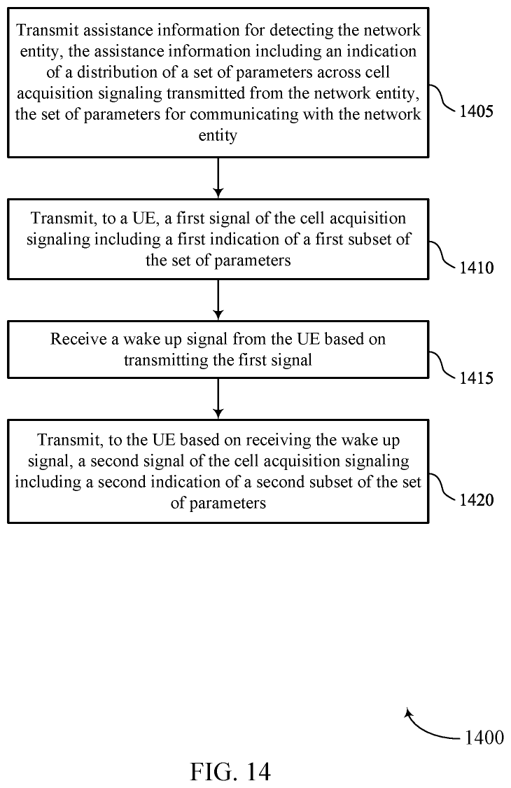

FIG. 14 shows a flowchart illustrating a method 1400 that supports on-demand synchronization signaling for network energy savings systems in accordance with one or more aspects of the present disclosure. The operations of the method 1400 may be implemented by a network entity or its components as described herein. For example, the operations of the method 1400 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1405, the method may include transmitting assistance information for detecting the network entity, the assistance information including an indication of a distribution of a set of parameters across cell acquisition signaling transmitted from the network entity, the set of parameters for communicating with the network entity. The operations of 1405 may be performed in accordance with examples as disclosed herein. In some examples, aspects of the operations of 1405 may be performed by an assistance information manager 1025 as described with reference to FIG. 10.

At 1410, the method may include transmitting, to a UE, a first signal of the cell acquisition signaling including a first indication of a first subset of the set of parameters. The operations of 1410 may be performed in accordance with examples as disclosed herein. In some examples, aspects of the operations of 1410 may be performed by a cell acquisition signaling manager 1030 as described with reference to FIG. 10.

At 1415, the method may include receiving a wake up signal from the UE based on transmitting the first signal. The operations of 1415 may be performed in accordance with examples as disclosed herein. In some examples, aspects of the operations of 1415 may be performed by a wake up signal manager 1035 as described with reference to FIG. 10.

At 1420, the method may include transmitting, to the UE based on receiving the wake up signal, a second signal of the cell acquisition signaling including a second indication of a second subset of the set of parameters. The operations of 1420 may be performed in accordance with examples as disclosed herein. In some examples, aspects of the operations of 1420 may be performed by a cell acquisition signaling manager 1030 as described with reference to FIG. 10.

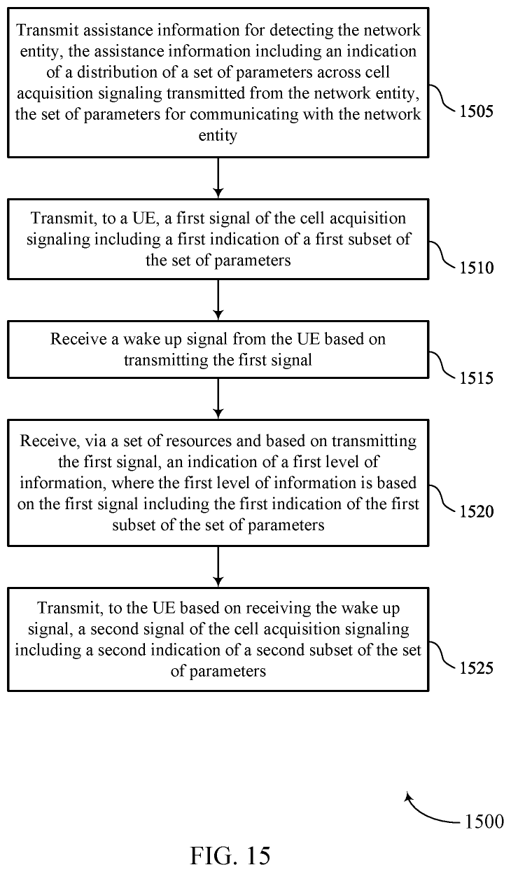

FIG. 15 shows a flowchart illustrating a method 1500 that supports on-demand synchronization signaling for network energy savings systems in accordance with one or more aspects of the present disclosure. The operations of the method 1500 may be implemented by a network entity or its components as described herein. For example, the operations of the method 1500 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1505, the method may include transmitting assistance information for detecting the network entity, the assistance information including an indication of a distribution of a set of parameters across cell acquisition signaling transmitted from the network entity, the set of parameters for communicating with the network entity. The operations of 1505 may be performed in accordance with examples as disclosed herein. In some examples, aspects of the operations of 1505 may be performed by an assistance information manager 1025 as described with reference to FIG. 10.

At 1510, the method may include transmitting, to a UE, a first signal of the cell acquisition signaling including a first indication of a first subset of the set of parameters. The operations of 1510 may be performed in accordance with examples as disclosed herein. In some examples, aspects of the operations of 1510 may be performed by a cell acquisition signaling manager 1030 as described with reference to FIG. 10.

At 1515, the method may include receiving a wake up signal from the UE based on transmitting the first signal. The operations of 1515 may be performed in accordance with examples as disclosed herein. In some examples, aspects of the operations of 1515 may be performed by a wake up signal manager 1035 as described with reference to FIG. 10.

At 1520, the method may include receiving, via a set of resources and based on transmitting the first signal, an indication of a first level of information, where the first level of information is based on the first signal including the first indication of the first subset of the set of parameters. The operations of 1520 may be performed in accordance with examples as disclosed herein. In some examples, aspects of the operations of 1520 may be performed by an information level manager 1045 as described with reference to FIG. 10.

At 1525, the method may include transmitting, to the UE based on receiving the wake up signal, a second signal of the cell acquisition signaling including a second indication of a second subset of the set of parameters. The operations of 1525 may be performed in accordance with examples as disclosed herein. In some examples, aspects of the operations of 1525 may be performed by a cell acquisition signaling manager 1030 as described with reference to FIG. 10.

The following provides an overview of aspects of the present disclosure:
Aspect 1: A method for wireless communications at a UE, comprising: receiving assistance information for detecting a network entity, the assistance information including an indication of a distribution of a set of parameters across cell acquisition signaling for the network entity, the set of parameters for communicating with the network entity; receiving, from the network entity, a first signal of the cell acquisition signaling including a first indication of a first subset of the set of parameters; transmitting a WUS to the network entity based at least in part on receiving the first signal; and receiving, from the network entity based at least in part on transmitting the WUS, a second signal of the cell acquisition signaling comprising a second indication of a second subset of the set of parameters.
Aspect 2: The method of aspect 1, wherein the first signal comprises an PSS and the second signal comprises an SSS and a PBCH.
Aspect 3: The method of aspect 1, wherein the first signal comprises an SSS and the second signal comprises an PSS and a PBCH.
Aspect 4: The method of aspect 1, wherein the first signal comprises an PSS and an SSS and the second signal comprises a standalone PBCH.
Aspect 5: The method of aspect 1, wherein the first signal comprises a CSI-RS or a TRS and the second signal comprises a PDCCH and an PDSCH carrying partial MIB and SIB information or a non-scheduling PDCCH.
Aspect 6: The method of any of aspects 1 through 5, wherein the set of parameters comprise an index for a set of cell IDs, one or more least significant bits of a beam index, a half-frame index, one or more least significant bits of a system frame number, a symbol index, or an anchor cell timing delta value, an index for a configuration of a set of configurations, or any combination thereof.
Aspect 7: The method of aspect 6, further comprising: determining, based at least in part on the index for the set of cell IDs, one or more candidate cells available for communications with an anchor cell, the UE, or both, wherein at least one of the one or more candidate cells is associated with the network entity.
Aspect 8: The method of any of aspects 1 through 7, further comprising: receiving, from an anchor cell, an indication of a set of configurations for one or more signals communicated by the network entity, the set of configurations including a cell identifier, timing information, frequency information, spatial information, beam information, cell barring information, a resource configuration, or any combination thereof.
Aspect 9: The method of aspect 8, further comprising: receiving, from the network entity, an indication of an index for a configuration of the set of configurations; and identifying a format of the second signal based at least in part on the index, wherein the UE receives the second signal in accordance with the configuration of the set of configurations and based at least in part on identifying the format of the second signal.
Aspect 10: The method of any of aspects 8 through 9, wherein the one or more signals include the second signal of the cell acquisition signaling.
Aspect 11: The method of any of aspects 1 through 10, further comprising: receiving, from an anchor cell, an indication of a configuration for transmitting the WUS, the configuration indicating resources associated with a first level of information associated with the first subset of the set of parameters; and transmitting, via the resources indicated in the configuration, an indication of the first level of information based at least in part on receiving the indication, wherein the first level of information is based at least in part on the first signal of the cell acquisition signaling including the first indication of the first subset of the set of parameters.
Aspect 12: The method of aspect 11, wherein the UE transmits the indication of the first level of information via the WUS, the indication included in a scrambling identifier of the WUS, a preamble identifier of the WUS, a cyclic shift value of the WUS, a message payload transmitted by the UE, or any combination thereof.
Aspect 13: The method of any of aspects 1 through 12, wherein transmitting the WUS further comprises: transmitting an indication of an index for a first level of information associated with the first subset of the set of parameters, wherein the first level of information is preconfigured at the UE.
Aspect 14: The method of any of aspects 1 through 13, wherein receiving the second signal further comprises: receiving an indication of a second level of information associated with the second signal and the second subset of the set of parameters based at least in part on transmitting the WUS to the network entity.
Aspect 15: The method of aspect 14, wherein the UE receives the indication via a header in a payload of the second signal, a flag in a physical downlink control channel associated with the second signal, a scrambling identifier, a demodulation reference signal associated with the second signal, time and frequency resources associated with receiving the second signal, or any combination thereof.
Aspect 16: The method of any of aspects 1 through 15, further comprising: receiving, from the network entity and based at least in part on receiving the second signal, a third signal of the cell acquisition signaling comprising a third subset of the set of parameters.
Aspect 17: A method for wireless communications at a network entity, comprising: transmitting assistance information for detecting the network entity, the assistance information including an indication of a distribution of a set of parameters across cell acquisition signaling transmitted from the network entity, the set of parameters for communicating with the network entity; transmitting, to a UE, a first signal of the cell acquisition signaling including a first indication of a first subset of the set of parameters; receiving a WUS from the UE based at least in part on transmitting the first signal; and transmitting, to the UE based at least in part on receiving the WUS, a second signal of the cell acquisition signaling comprising a second indication of a second subset of the set of parameters.
Aspect 18: The method of aspect 17, wherein the first signal comprises an PSS and the second signal comprises an SSS and a PBCH.
Aspect 19: The method of aspect 17, wherein the first signal comprises an SSS and the second signal comprises an PSS and a PBCH.
Aspect 20: The method of aspect 17, wherein the first signal comprises an PSS and an SSS and the second signal comprises a standalone PBCH.
Aspect 21: The method of aspect 17, wherein the first signal comprises a CSI-RS or a TRS and the second signal comprises a PDCCH and an PDSCH carrying partial MIB and SIB information or a non-scheduling PDCCH.
Aspect 22: The method of any of aspects 17 through 21, wherein the set of parameters comprise an index for a set of cell IDs, one or more least significant bits of a beam index, a half-frame index, one or more least significant bits of a system frame number, a symbol index, or an anchor cell timing delta value, an index for a configuration of a set of configurations, or any combination thereof.
Aspect 23: The method of any of aspects 17 through 22, further comprising: transmitting, to the UE, an indication of an index for a configuration of a set of configurations for one or more signals communicated by the network entity, the set of configurations including a cell identifier, timing information, frequency information, spatial information, beam information, cell barring information, a resource configuration, or any combination thereof; and transmitting a signal of the one or more signals in accordance with the configuration of the set of configurations.
Aspect 24: The method of any of aspects 17 through 23, further comprising: receiving, via a set of resources and based at least in part on transmitting the first signal, an indication of a first level of information, wherein the first level of information is based at least in part on the first signal including the first indication of the first subset of the set of parameters.
Aspect 25: The method of any of aspects 17 through 24, wherein receiving the WUS further comprises: receiving an indication of an index for a first level of information associated with the first subset of the set of parameters, wherein the first level of information is preconfigured at the UE.
Aspect 26: The method of any of aspects 17 through 25, wherein transmitting the second signal further comprises: transmitting an indication of a second level of information associated with the second signal and the second subset of the set of parameters based at least in part on receiving the WUS from the UE.
Aspect 27: The method of any of aspects 17 through 26, further comprising: transmitting, to the UE and based at least in part on transmitting the second signal, a third signal of the cell acquisition signaling comprising a third subset of the set of parameters.
Aspect 28: The method of any of aspects 17 through 27, wherein the network entity is associated with one or more NES cells.
Aspect 29: A UE comprising one or more memories storing processor-executable code, and one or more processors coupled with the one or more memories and individually or collectively operable to execute the code to cause the UE to perform a method of any of aspects 1 through 16.
Aspect 30: A UE comprising at least one means for performing a method of any of aspects 1 through 16.
Aspect 31: A non-transitory computer-readable medium storing code the code comprising instructions executable by one or more processors to perform a method of any of aspects 1 through 16.
Aspect 32: A network entity comprising one or more memories storing processor-executable code, and one or more processors coupled with the one or more memories and individually or collectively operable to execute the code to cause the network entity to perform a method of any of aspects 17 through 28.
Aspect 33: A network entity comprising at least one means for performing a method of any of aspects 17 through 28.
Aspect 34: A non-transitory computer-readable medium storing code the code comprising instructions executable by one or more processors to perform a method of any of aspects 17 through 28.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive assistance information for detecting a network entity, the assistance information including an indication of a distribution of a set of parameters across cell acquisition signaling for the network entity, the set of parameters for communicating with the network entity;
receive, from the network entity, a first signal of the cell acquisition signaling including a first indication of a first subset of the set of parameters;
transmit a wake up signal to the network entity based at least in part on receiving the first signal; and
receive, from the network entity based at least in part on transmitting the wake up signal, a second signal of the cell acquisition signaling comprising a second indication of a second subset of the set of parameters.

2. The UE of claim 1, wherein the first signal comprises a primary synchronization signal (PSS) and the second signal comprises a secondary synchronization signal (SSS) and a physical broadcast channel (PBCH).

3. The UE of claim 1, wherein the first signal comprises a secondary synchronization signal (SSS) and the second signal comprises a primary synchronization signal (PSS) and a physical broadcast channel (PBCH).

4. The UE of claim 1, wherein the first signal comprises a primary synchronization signal (PSS) and a secondary synchronization signal (SSS) and the second signal comprises a standalone physical broadcast channel (PBCH).

5. The UE of claim 1, wherein the first signal comprises a channel state information reference signal (CSI-RS) or a tracking reference signal (TRS) and the second signal comprises a physical downlink control channel (PDCCH) and a physical downlink shared channel (PDSCH) carrying partial master information block (MIB) and system information block (SIB) information or a non-scheduling PDCCH.

6. The UE of claim 1, wherein the set of parameters comprise an index for a set of cell identifiers (IDs), one or more least significant bits of a beam index, a half-frame index, one or more least significant bits of a system frame number, a symbol index, or an anchor cell timing delta value, an index for a configuration of a set of configurations, or any combination thereof.

7. The UE of claim 6, wherein the one or more processors are individually or collectively further operable to execute the code to cause the UE to:
determine, based at least in part on the index for the set of cell IDs, one or more candidate cells available for communications with an anchor cell, the UE, or both, wherein at least one of the one or more candidate cells is associated with the network entity.

8. The UE of claim 1, wherein the one or more processors are individually or collectively further operable to execute the code to cause the UE to:
receive, from an anchor cell, an indication of a set of configurations for one or more signals communicated by the network entity, the set of configurations including a cell identifier, timing information, frequency information, spatial information, beam information, cell barring information, a resource configuration, or any combination thereof.

9. The UE of claim 8, wherein the one or more processors are individually or collectively further operable to execute the code to cause the UE to:
receive, from the network entity, an indication of an index for a configuration of the set of configurations; and
identify a format of the second signal based at least in part on the index, wherein the UE receives the second signal in accordance with the configuration of the set of configurations and based at least in part on identifying the format of the second signal.

10. The UE of claim 8, wherein the one or more signals include the second signal of the cell acquisition signaling.

11. The UE of claim 1, wherein the one or more processors are individually or collectively further operable to execute the code to cause the UE to:
receive, from an anchor cell, an indication of a configuration for transmitting the wake up signal, the configuration indicating resources associated with a first level of information associated with the first subset of the set of parameters; and
transmit, via the resources indicated in the configuration, an indication of the first level of information based at least in part on receiving the indication, wherein the first level of information is based at least in part on the first signal of the cell acquisition signaling including the first indication of the first subset of the set of parameters.

12. The UE of claim 11, wherein the UE transmits the indication of the first level of information via the wake up signal, the indication included in a scrambling identifier of the wake up signal, a preamble identifier of the wake up signal, a cyclic shift value of the wake up signal, a message payload transmitted by the UE, or any combination thereof.

13. The UE of claim 1, wherein, to transmit the wake up signal, the one or more processors are individually or collectively further operable to execute the code to cause the UE to:
transmit an indication of an index for a first level of information associated with the first subset of the set of parameters, wherein the first level of information is preconfigured at the UE.

14. The UE of claim 1, wherein, to receive the second signal, the one or more processors are individually or collectively further operable to execute the code to cause the UE to:
receive an indication of a second level of information associated with the second signal and the second subset of the set of parameters based at least in part on transmitting the wake up signal to the network entity.

15. The UE of claim 14, wherein the UE receives the indication via a header in a payload of the second signal, a flag in a physical downlink control channel associated with the second signal, a scrambling identifier, a demodulation reference signal associated with the second signal, time and frequency resources associated with receiving the second signal, or any combination thereof.

16. The UE of claim 1, wherein the one or more processors are individually or collectively further operable to execute the code to cause the UE to:
receive, from the network entity and based at least in part on receiving the second signal, a third signal of the cell acquisition signaling comprising a third subset of the set of parameters.

17. A network entity, comprising:
one or more memories storing processor-executable code; and
one or more processors coupled with the one or more memories and individually or collectively operable to execute the code to cause the network entity to:
transmit assistance information for detecting the network entity, the assistance information including an indication of a distribution of a set of parameters across cell acquisition signaling transmitted from the network entity, the set of parameters for communicating with the network entity;
transmit, to a UE, a first signal of the cell acquisition signaling including a first indication of a first subset of the set of parameters;
receive a wake up signal from the UE based at least in part on transmitting the first signal; and
transmit, to the UE based at least in part on receiving the wake up signal, a second signal of the cell acquisition signaling comprising a second indication of a second subset of the set of parameters.

18. The network entity of claim 17, wherein the first signal comprises a primary synchronization signal (PSS) and the second signal comprises a secondary synchronization signal (SSS) and a physical broadcast channel (PBCH).

19. The network entity of claim 17, wherein the first signal comprises a secondary synchronization signal (SSS) and the second signal comprises a primary synchronization signal (PSS) and a physical broadcast channel (PBCH).

20. The network entity of claim 17, wherein the first signal comprises a primary synchronization signal (PSS) and a secondary synchronization signal (SSS) and the second signal comprises a standalone physical broadcast channel (PBCH).

21. The network entity of claim 17, wherein the first signal comprises a channel state information reference signal (CSI-RS) or a tracking reference signal (TRS) and the second signal comprises a physical downlink control channel (PDCCH) and a physical downlink shared channel (PDSCH) carrying partial master information block (MIB) and system information block (SIB) information or a non-scheduling PDCCH.

22. The network entity of claim 17, wherein the set of parameters comprise an index for a set of cell identifiers (IDs), one or more least significant bits of a beam index, a half-frame index, one or more least significant bits of a system frame number, a symbol index, or an anchor cell timing delta value, an index for a configuration of a set of configurations, or any combination thereof.

23. The network entity of claim 17, wherein the one or more processors are individually or collectively further operable to execute the code to cause the network entity to:
transmit, to the UE, an indication of an index for a configuration of a set of configurations for one or more signals communicated by the network entity, the set of configurations including a cell identifier, timing information, frequency information, spatial information, beam information, cell barring information, a resource configuration, or any combination thereof; and
transmit a signal of the one or more signals in accordance with the configuration of the set of configurations.

24. The network entity of claim 17, wherein the one or more processors are individually or collectively further operable to execute the code to cause the network entity to:
receive, via a set of resources and based at least in part on transmitting the first signal, an indication of a first level of information, wherein the first level of information is based at least in part on the first signal including the first indication of the first subset of the set of parameters.

25. The network entity of claim 17, wherein, to receive the wake up signal, the one or more processors are individually or collectively further operable to execute the code to cause the network entity to:
receive an indication of an index for a first level of information associated with the first subset of the set of parameters, wherein the first level of information is preconfigured at the UE.

26. The network entity of claim 17, wherein, to transmit the second signal, the one or more processors are individually or collectively further operable to execute the code to cause the network entity to:
transmit an indication of a second level of information associated with the second signal and the second subset of the set of parameters based at least in part on receiving the wake up signal from the UE.

27. The network entity of claim 17, wherein the one or more processors are individually or collectively further operable to execute the code to cause the network entity to:
transmit, to the UE and based at least in part on transmitting the second signal, a third signal of the cell acquisition signaling comprising a third subset of the set of parameters.

28. The network entity of claim 17, wherein the network entity is associated with one or more network energy savings (NES) cells.

29. A method for wireless communications at a user equipment (UE), comprising:
receiving assistance information for detecting a network entity, the assistance information including an indication of a distribution of a set of parameters across cell acquisition signaling for the network entity, the set of parameters for communicating with the network entity;
receiving, from the network entity, a first signal of the cell acquisition signaling including a first indication of a first subset of the set of parameters;
transmitting a wake up signal to the network entity based at least in part on receiving the first signal; and
receiving, from the network entity based at least in part on transmitting the wake up signal, a second signal of the cell acquisition signaling comprising a second indication of a second subset of the set of parameters.

30. A method for wireless communications at a network entity, comprising:
transmitting assistance information for detecting the network entity, the assistance information including an indication of a distribution of a set of parameters across cell acquisition signaling transmitted from the network entity, the set of parameters for communicating with the network entity;
transmitting, to a UE, a first signal of the cell acquisition signaling including a first indication of a first subset of the set of parameters;
receiving a wake up signal from the UE based at least in part on transmitting the first signal; and
transmitting, to the UE based at least in part on receiving the wake up signal, a second signal of the cell acquisition signaling comprising a second indication of a second subset of the set of parameters.
